(19) United States
(12) Patent Application Publication
(10) Pub. No.: US 2006/0028523 A1
(43) Pub. Date: Feb. 9, 2006

(54) Ink jet recording apparatus

(75) Inventor: Yoshihide Hoshino, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA MEDICAL & GRAPHIC, INC., Tokyo (JP)

(21) Appl. No.: 11/186,700

(22) Filed: Jul. 21, 2005

(30) Foreign Application Priority Data
Aug. 6, 2004 (JP) JP2004-230891

(51) Int. Cl. B41J 2/01

(52) U.S. Cl. 347/102

(57) ABSTRACT

There is described an ink jet recording apparatus for properly adjusting the ink amount to be emitted onto a recording medium, to realize a reproduction of a high-resolution image free of sandy parts and uneven parts on the image surface. The inkjet recording apparatus includes: a recording head to emit a photo-curing ink, to be cured by irradiating a light, onto a recording medium; a light irradiating device having a light source that irradiates the light onto the photo-curing ink; and a controlling section to determine a maximum recording rate, so that the maximum recording rate is set at a value in a range of 80-95% when a recording rate of whole pixels to be recorded for every unicolor is set at 100%. The controlling section determines the maximum recording rate for every unicolor corresponding to a kind of the recording medium to be employed.

This application is based on Japanese Patent Application NO. 2004-230891 filed on Aug. 6, 2004 in Japanese Patent Office, the entire content of which is hereby incorporated by reference.

### BACKGROUND OF THE INVENTION

The present invention relates to an ink jet recording apparatus and more particularly to an ink jet recording apparatus for recording images using photo-curing ink cured by irradiation of light.

Generally, as an ink jet recording apparatus responding to a low-volume, high-variety demand according to circumstances, an ink jet type recording apparatus (hereinafter, referred to as an “ink jet recording apparatus”) is conventionally known. The ink jet recording apparatus emits ink from a nozzle installed on the opposite face of a recording head to a recording medium, hits and fixes it on the recording medium, thereby records an image on the recording medium, and unlike the conventional image recording apparatus by the photogravure printing method or flexographic printing method, requires no plate making process, thus can respond to a low-volume demand simply and quickly. Further, the ink jet recording apparatus makes little noise and uses polychrome ink, so that it has an advantage that color images can be recorded easily.

Furthermore, in recent years, as an ink jet recording apparatus responding to various recording media, an ink jet recording apparatus using photo-curing ink is known (for example, refer to Patent Document 1). The apparatus uses photo-curing ink containing a photo-starting agent having predetermined sensitivity to light such as ultraviolet rays, irradiates light to ink hit onto a recording medium, cures the ink, and fixes it on the recording medium. The ink jet recording apparatus using such photo-curing ink irradiates light to it after hitting, so that the ink is cured instantaneously, thus penetration and permeation of ink into the recording medium are a little, and not only on ordinary paper but also on a recording medium such as plastics or metals having no ink receiving layer and no ink absorbency, images can be recorded.

However, generally, when recording an image by using aqueous or oil ink and a recording medium having an ink receiving layer, the majority of the ink is absorbed by the recording medium, while when recording an image on a recording medium having no ink receiving layer using photo-curing ink, the ink is cured and fixed simultaneously with irradiation of light and is not absorbed by the recording medium, so that the ink remains on the surface of the recording medium and is cured in a state that the ink hit part rises.

Therefore, sandy parts and uneven parts are generated on the surface of the recorded image and are visually checked as variations in the gloss feeling. Thus the image quality as a whole is lowered and a problem arises that high resolution image recording cannot be executed.

On the other hand, in the ink jet recording apparatus, due to an occurrence of ink emission bending that the ink emitting direction is bent due to adherence of ink to the nozzle of the recording head for emitting ink, the ink hitting position may be shifted. Therefore, when ink is emitted so as to form dots in the same size as that of the theoretical pixels, if the hitting position of ink is shifted even slightly, gaps are generated between dots, and stripes are generated on the recorded image, and a problem arises that the image quality is lowered. Therefore, it is necessary to emit ink so as to form dots larger than the theoretical pixels and the problem that sandy parts and uneven parts are generated on the surface of the recorded image becomes more remarkable.

For such problems, conventionally, when recording a color image by using a recording head for emitting polychromatic ink and superimposing and printing a plurality of ink on the same pixels, an art for reducing the ink amount according to the ratio of ink of each color when the ink amount per unit area reaches a fixed amount and adjusting the ink amount as a whole is known (for example, refer to Patent Document 2).

However, this art adjusts each ink amount of the polychromatic ink, so that a problem arises that when emitting individually each ink, it cannot adjust properly the ink amount and cannot prevent the surface of the recorded image from an occurrence of sandy parts and uneven parts.

### SUMMARY OF THE INVENTION

To overcome the abovementioned drawbacks in conventional ink jet recording apparatus, it is an object of the present invention to provide an ink jet recording apparatus for properly adjusting the ink amount even when emitting individually each ink and realizing high-resolution image recording free of sandy parts and uneven parts on the image surface.

Accordingly, to overcome the cited shortcomings, the abovementioned object of the present invention can be attained by ink jet recording apparatus described as follow.

(1) An inkjet recording apparatus, comprising: a recording head to emit a photo-curing ink, to be cured by irradiating a light, onto a recording medium; a light irradiating device having a light source that irradiates the light onto the photo-curing ink emitted by the recording head; and a controlling section to determine a maximum recording rate, so that the maximum recording rate is set at a value in a range of 80-90% when a recording rate of whole pixels to be recorded for every unicolor is set at 100%.

(2) The inkjet recording apparatus of item 1, wherein the controlling section determines the maximum recording rate for every unicolor corresponding to a kind of the recording medium to be employed.

(3) The inkjet recording apparatus of item 1, wherein the controlling section determines the maximum recording rate for every unicolor corresponding to a resolution.

(4) The inkjet recording apparatus of item 1, further comprising: a measuring section to measure at least one of a temperature and a humidity around a peripheral area of the recording head; wherein the controlling section determines the maximum recording rate for every unicolor corresponding to at least one of the temperature and the humidity measured by the measuring section.

(5) The inkjet recording apparatus of item 1, further comprising: an irradiation intensity measuring section to measure an irradiation intensity of the light irradiated by the light irradiating device; wherein the controlling section determines the maximum recording rate for every unicolor corresponding to the irradiation intensity measured by the irradiation intensity measuring section.

(6) The inkjet recording apparatus of item 1, wherein the controlling section determines the maximum recording rate for every unicolor corresponding to a recording velocity at a time of a recording operation.

(7) The inkjet recording apparatus of item 1, wherein the recording head corresponds to each of a plurality of recording heads and the photo-curing ink corresponds to each of a plurality of photo-curing inks, colors of which are different from each other; and wherein each of the plurality of recording heads is disposed for each of the plurality of photo-curing inks and the controlling section determines the maximum recording rate for every unicolor corresponding to a kind of the photo-curing ink.

(8) The inkjet recording apparatus of item 1, wherein the controlling section is capable of controlling at least one of an amount of ink and a number of ink particles to be emitted from the recording head, and determines the maximum recording rate for every unicolor corresponding to the amount of ink or the number of ink particles.

(9) The inkjet recording apparatus of item 1, wherein, after the maximum recording rate is determined, the controlling section conducts a multiple-value conversion processing suitable for the inkjet recording apparatus to determine pixels to be recorded for every unicolor, and conducts a controlling operation to emit the photo-curing ink corresponding to the pixels determined to be recorded.

(10) The inkjet recording apparatus of item 1, wherein the light is defined as activation energy rays for curing the photo-curing ink.

(11) An inkjet recording method, comprising the steps of: emitting a photo-curing ink, to be cured by irradiating a light, onto a recording medium; and irradiating the light onto the photo-curing ink adhered to the recording medium; determining a maximum recording rate for every unicolor, so that the maximum recording rate is set at a value in a range of 80-90% when a recording rate of whole pixels to be recorded for every unicolor is set at 100%.

(12) The inkjet recording method of item 11, wherein the maximum recording rate for every unicolor is determined corresponding to a kind of the recording medium to be employed.

(13) The inkjet recording method of item 11, wherein the maximum recording rate for every unicolor is determined corresponding to a resolution.

(14) The inkjet recording method of item 11, further comprising the step of: measuring at least one of a temperature and a humidity around a peripheral area of the recording head; wherein the maximum recording rate for every unicolor is determined corresponding to at least one of the temperature and the humidity measured in the measuring step.

(15) The inkjet recording method of item 11, further comprising the step of: measuring an irradiation intensity of the light irradiated in the irradiating step; wherein the maximum recording rate for every unicolor is determined corresponding to the irradiation intensity measured in the measuring step.

(16) The inkjet recording method of item 11, wherein the maximum recording rate for every unicolor is determined corresponding to a recording velocity at a time of a recording operation.

(17) The inkjet recording method of item 11, wherein the maximum recording rate for every unicolor is determined corresponding to a kind of the photo-curing ink.

(18) The inkjet recording method of item 11, further comprising the step of: controlling at least one of an amount of ink and a number of ink particles to be emitted in the emitting step; wherein the maximum recording rate for every unicolor is determined corresponding to the amount of ink or the number of ink particles.

(19) The inkjet recording method of item 11, wherein, after the maximum recording rate is determined, a multiple-value conversion processing is conducted to determine pixels to be recorded for every unicolor, and then, a controlling operation is conducted to emit the photo-curing ink corresponding to the pixels determined to be recorded.

(20) The inkjet recording method of item 11, wherein the light is defined as activation energy rays for curing the photo-curing ink.

Further, to overcome the abovementioned problems, other inkjet recording apparatus, embodied in the present invention, will be described as follow:

(21) An inkjet recording apparatus, characterized in that
the inkjet recording apparatus is provided with a recording head to emit a photo-curing ink, to be cured by irradiating a light, onto a recording medium, and a light irradiating device having a light source that irradiates the light onto the emitted ink; and
when a recording rate for recording all pixels per one color is 100%, a controlling section, which determines a maximum recording rate per one color by the recording head so as to set it in a range of 80-90%, is equipped.

According to the invention mentioned in the above, the controlling section determines the maximum recording rate per one color within a range of 80-90%, to emit a predetermined amount of ink from the recording head.

(22) The inkjet recording apparatus recited in item 21, characterized in that
the controlling section determines a maximum recording rate per one color corresponding to a kind of the recording medium.

According to the invention mentioned in the above, since the controlling section determines the maximum recording rate per one color corresponding to a kind of the recording medium, it is possible to conduct an image reading operation with employing an ink amount suitable for ink absorption of the recording medium, degree of surface energy, etc.

(23) The inkjet recording apparatus recited in item 21 or 22, characterized in that
the controlling section determines a maximum recording rate per one color corresponding to a resolution.

According to the invention mentioned in the above, since the controlling section determines the maximum recording rate per one color corresponding to a resolution, it is possible to conduct an image reading operation with employing an ink amount suitable for a desired resolution.

(24) The inkjet recording apparatus recited in any one of items 21-23, characterized in that the inkjet recording apparatus is further provided with measuring means for measuring at least one of a temperature and a humidity around a peripheral area of the recording head; and
the controlling section determines a maximum recording rate per one color corresponding to at least one of the temperature and the humidity around a peripheral area of the recording head, measured by the measuring means.

According to the invention mentioned in the above, since the controlling section determines the maximum recording rate per one color corresponding to the temperature or the humidity around a peripheral area of the recording head, it is possible to conduct an image reading operation with employing an ink amount suitable for the temperature or the humidity conditions.

(25) The inkjet recording apparatus recited in any one of items 21-24, characterized in that the inkjet recording apparatus is further provided with irradiation intensity measuring means for measuring an irradiation intensity of the light irradiated by the light irradiating device; and the controlling section determines a maximum recording rate per one color corresponding to the irradiation intensity measured by the irradiation intensity measuring means.

According to the invention mentioned in the above, since the controlling section determines the maximum recording rate per one color corresponding to the irradiation intensity measured by the irradiation intensity measuring means, it is possible to conduct an image reading operation with employing an ink amount suitable for the irradiation intensity of the light.

(26) The inkjet recording apparatus recited in any one of items 21-25, characterized in that the controlling section determines a maximum recording rate per one color corresponding to an image recording velocity at a time of a recording operation.

According to the invention mentioned in the above, since the controlling section determines the maximum recording rate per one color corresponding to the image recording velocity, it is possible to conduct an image reading operation with employing an ink amount suitable for ink curing timing, which varies depending on the image recording velocity.

(27) The inkjet recording apparatus recited in any one of items 21-26, characterized in that
a plurality of recording heads are disposed for every color ink, the controlling section determines a maximum recording rate per one color corresponding to a kind of ink.

According to the invention mentioned in the above, when the image recording operation is conducted by employing a plurality of color inks, since the controlling section determines the maximum recording rate per one color corresponding to a kind of ink, it is possible to conduct an image reading operation with employing an ink amount suitable for each of the color inks.

(28) The inkjet recording apparatus recited in any one of items 21-27, characterized in that
the controlling section is capable of controlling at least one of an amount of ink and a number of ink particles to be emitted from the recording head, and determines the maximum recording rate per one color corresponding to the amount of ink or the number of ink particles.

According to the invention mentioned in the above, the controlling section determines the maximum recording rate per one color corresponding to the amount of ink or the number of ink particles, and adjusts the total amount of ink.

(29) The inkjet recording apparatus recited in any one of items 21-28, characterized in that
after the maximum recording rate is determined, the controlling section conducts a multiple-value conversion image processing suitable for the inkjet recording apparatus, and determines pixels to be recorded per one color, and conducts a controlling operation to emit the ink onto the pixels determined to be recorded.

According to the invention mentioned in the above, after the controlling section determines the maximum recording rate per one color, the controlling section conducts a multiple-value conversion image processing suitable for the inkjet recording apparatus to determine the pixels to be recorded.

### BRIEF DESCRIPTION OF THE DRAWINGS

Other objects and advantages of the present invention will become apparent upon reading the following detailed description and upon reference to the drawings in which:

FIG. 1 is a top view showing the essential constitution of the first embodiment of the ink jet recording apparatus relating to the present invention;

FIG. 2 is a block diagram of the essential section showing the schematic control constitution of the first embodiment of the ink jet recording apparatus relating to the present invention;

FIG. 3(a) is a drawing concretely showing the contents of the LUT concerning an ink emission amount decision process of the first embodiment of the ink jet recording apparatus relating to the present invention, and FIG. 3(b) is a drawing concretely showing the contents of the LUT for specifying a maximum recording rate corresponding to the ink emission amount, and FIG. 3(c) is a drawing concretely showing the contents of the LUT for specifying the correction amount for each ink kind;

FIG. 4 is a graph showing the relationship between recording media and extent of dots;

FIG. 5 is a block diagram of the essential section showing the schematic control constitution of the second embodiment of the ink jet recording apparatus relating to the present invention;

FIG. 6(a) is a drawing concretely showing the contents of the LUT concerning a main scanning speed decision process of a carriage of the first embodiment of the ink jet recording apparatus relating to the present invention and FIG. 6(b) is a drawing concretely showing the contents of the LUT for specifying a maximum recording rate corresponding to the main scanning speed;

FIG. 7 is a table showing evaluation of whether uneven parts can be seen on the image surface or not when visually checking a recorded image in the relationship between the environmental temperature, environmental humidity, carriage speed, and recording rate for each color as an embodiment of the ink jet recording apparatus relating to the present invention;

FIG. 8 is a table showing evaluation of whether uneven parts can be seen on the image surface or not when visually checking a recorded image in the relationship between the environmental temperature, environmental humidity, carriage speed, ink emission amount, and recording rate for each color as an embodiment of the ink jet recording apparatus relating to the present invention;

FIG. 9 is a table showing evaluation of whether uneven parts can be seen on the image surface or not when visually checking a recorded image in the relationship between the environmental temperature, environmental humidity, carriage speed, ink kind, and recording rate for each color as an embodiment of the ink jet recording apparatus relating to the present invention;

FIG. 10 is a table showing evaluation of whether uneven parts can be seen on the image surface or not when visually checking a recorded image in the relationship between the environmental temperature, environmental humidity, platen temperature, amount of ultraviolet rays, and recording rate for each color as an embodiment of the ink jet recording apparatus relating to the present invention; and

FIG. 11 is a table showing evaluation of whether uneven parts can be seen on the image surface or not when visually checking a recorded image in the relationship between the environmental temperature, environmental humidity, platen temperature, amount of ultraviolet rays, and recording rate for each color as an embodiment of the ink jet recording apparatus relating to the present invention.

### DETAILED DESCRIPTION OF THE PREFERRED EMBODIMENTS

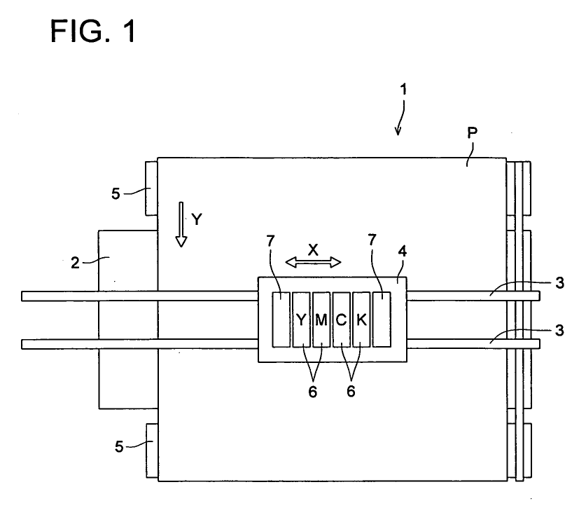

Hereinafter, by referring to FIGS. 1 to 4, the first embodiment of an ink jet recording apparatus 1 relating to the present invention will be explained.

Firstly, as shown in FIG. 1, in this embodiment, the ink jet recording apparatus 1 is an ink jet recording apparatus of a serial print type and in the ink jet recording apparatus 1, a platen 2 for supporting a recording medium P formed flatly from its non-recording face is installed.

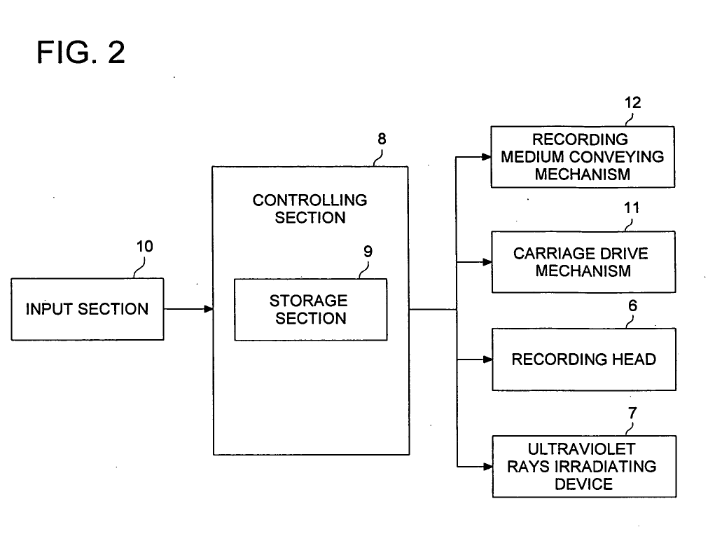

Above the platen 2, cylindrical guide rails 3 extending in the longitudinal direction of the platen 2 are installed. A carriage 4 is supported by the guide rails 3 and freely moves back and forth in the main scanning direction X along the guide rails 4 by a carriage drive mechanism 11 (refer to FIG. 2).

Further, in the ink jet recording apparatus 1, a recording medium conveying mechanism 12 (refer to FIG. 2) composed of a plurality of conveying rollers 5 for sending the recording medium P in the sub-scanning direction Y perpendicular to the main scanning direction X. The recording medium conveying mechanism 12 rotates the conveying rollers 5, thereby during image recording, repeatedly conveys and stops the recording medium P in accordance with the operation of the carriage 4, and conveys the recording medium P intermittently from the upstream side to the downstream side in the sub-scanning direction Y.

As shown in FIG. 1, on the carriage 4, four recording heads 6 corresponding to the colors (black (K), cyan (C), magenta (M), yellow (Y)) used in the ink jet recording apparatus 1 of this embodiment are loaded. The respective recording heads 6 have a structure of a rectangular parallelepiped and are arranged side by side so that they are parallel with each other in the longitudinal direction. On the opposite face of each recording head 6 to the recording medium P, a plurality of ink emission ports (not drawn) formed in line in the longitudinal direction of the recording head 6 are installed and each recording head 6 emits ink from its ink emission port. Further, the ink used in the ink jet recording apparatus 1 is not limited to the aforementioned and for example, light yellow (LY), light magenta (LM), and light cyan (LC) may be used. In this case, a recording head corresponding to each color is loaded in the carriage.

Between the recording heads 6 installed in the neighborhood of the side walls of the carriage 4 and both side walls of the carriage 4, ultraviolet irradiating devices 7 as a light irradiating device are arranged.

Each ultraviolet irradiating device 7 has an ultraviolet rays source (not drawn) for irradiating ultraviolet rays as light for curing and fixing ink emitted and hit onto the recording medium P. As an ultraviolet rays source, for example, a high-voltage mercury vapor lamp, a low-voltage mercury vapor lamp, a metal halide lamp, a semiconductor laser, a cold cathode ray tube, an excimer lamp, or an LED (light emitting diode) can be applied.

The ink used in this embodiment is photo-curing ink having a property of being cured by irradiation of ultraviolet rays as light and includes, as main components, at least a polymerizable compound (known polymerizable compound included), a photo-starting agent, and a coloring material. The aforementioned photo-curing ink is broadly divided into radical polymerization series ink including a radical polymerizable compound as a polymerizable compound and cationic polymerization series ink including a cationic polymerizable compound, though both series of ink can be respectively applied as ink used in this embodiment. Further, hybrid ink compounding radical polymerization series ink and cationic polymerization series ink may be applied as ink used in this embodiment. However, cationic polymerization series ink having little or no blocking operation of the polymerization reaction by oxygen is excellent in the function and wide use, so that it is preferable to use cationic polymerization series ink. Cationic polymerization series ink is a mixture including at least a cationic polymerizable compound such as an oxetane compound, an epoxy compound, or a vinyl ether compound, a light cationic starting agent, and a coloring material.

Further, as a recording medium P, a recording medium P composed of various kinds of paper such as ordinary paper, recycled paper, and glossy paper, various cloths, various non-woven fabrics, or various materials such as resin, metal, and glass can be applied. Further, as a form of the recording medium P, various forms such as roll shape, cut sheet shape, and laminal shape can be applied.

Next, by referring to FIG. 2, the control constitution of the ink jet recording apparatus 1 of this embodiment will be explained.

A controlling section 8 for controlling the ink jet recording apparatus 1 is installed and the controlling section 8 has, for example, a CPU not drawn. Further, the controlling section 8 has a storage section 9 composed of a ROM (Read Only Memory) for storing various processing programs and a RAM (Random Access Memory) for temporarily storing image data (both are not drawn). The controlling section 8 develops the processing programs stored in the ROM in the working area of the RAM and executes the processing programs by the CPU.

Further, the ink jet recording apparatus 1 has an input section 10 for inputting the kind of the recording medium P and image recording conditions and sends information input from the input section 10 to the controlling section 8. The input section 10 is, for example, a keyboard or an operation panel and a user, by operating the input section 10, can select and set the recording medium P to be used for image recording and a desired resolution.

Further, to the controlling section 8, image data concerning a recording image is sent, and the controlling section 8 performs a multi-leveling process of an image suited to image recording for the sent image data, and then operates the recording heads 6 on the basis of the input information from the input section 10. By doing this, an appropriate emission amount of ink is emitted from each recording head 6 and a predetermined image is recorded on the recording medium P. Here, the ink emission amount is the product of the liquid drop amount of one ink drop emitted from the emission port of each recording head 6 and the number of emitted liquid drops and the controlling section 8, to emit a predetermined emission amount of ink, controls the liquid drop amount or number of liquid drops of ink emitted from each recording head 6, thereby adjusts the ink amount. Further, as a multi-leveling process of an image, for example, the dither method or error variance method can be used.

Furthermore, the controlling section 8 controls the carriage drive mechanism 11, thereby moves the carriage 4 back and forth in the main scanning direction X, and so as to convey the recording medium P in the sub-scanning direction Y in accordance with the operation of the carriage 4, controls the operation of the recording medium conveying mechanism 12.

Further, the controlling section 8 controls the ultraviolet irradiating devices 7 so as to irradiate ultraviolet rays from the ultraviolet rays source.

In the storage section 9, for example, various control programs (not drawn) concerning the operation of each unit of the ink jet recording apparatus 1 and various data including control data (not drawn) relating to execution of various programs are stored and an ink emission amount look-up table (hereinafter, referred to as an “ink emission amount LUT”), a maximum recording rate look-up table (hereinafter, referred to as a “maximum recording rate LUT”), and a correction amount by ink kind look-up table (hereinafter, referred to as a “correction amount by ink kind LUT”) are stored. The controlling section 8, as required, reads these various programs and LUTs from the ROM, stores them in the working area of the RAM, controls each unit of the apparatus, and decides a maximum recording rate in image recording.

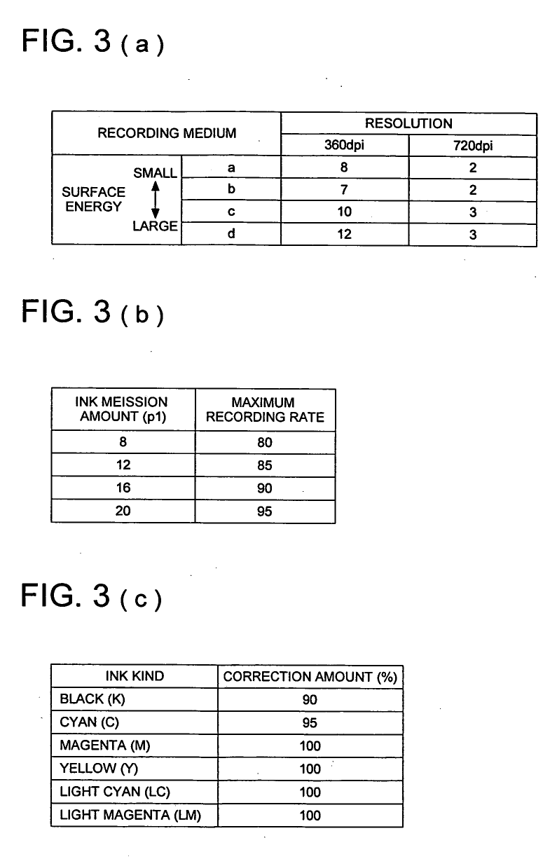

Here, the ink emission amount LUT, as shown in FIG. 3(a), is a table in which the ink emission amount corresponding to the recording medium P and desired resolution is specified.

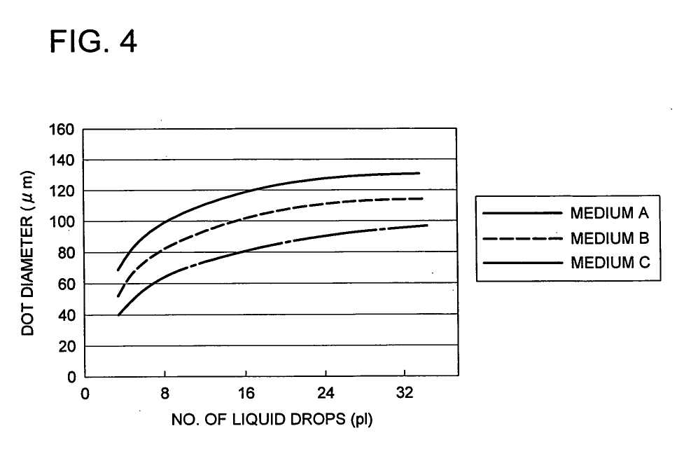

As shown in FIG. 4, ink differs in the extent of dots after hitting depending on the ink absorbency of the recording medium P where it hits and the magnitude of surface energy. For example, when ink hits a recording medium having low ink absorbency or a recording medium P having large surface energy (for example, medium C shown in FIG. 4), the ink hardly extends on the recording medium P, so that it is necessary to increase the ink emission amount. Inversely, when ink hits a recording medium P having high ink absorbency or a recording medium P (for example, medium A shown in FIG. 4) having small surface energy like PET (polyethylene terephthalate), the ink easily extends on the recording medium P, so that the ink emission amount can be reduced. Further, as the resolution is increased, an image is subdivided, and one pixel becomes smaller, so that the ink emission amount emitted to one pixel is reduced. The ink emission amount varies with the kind and resolution of the recording medium P like this, so that the ink emission amount LUT makes the recording medium P and resolution correspond to the ink emission amount.

For example, as shown in FIG. 3(a), when the recording medium P has high ink absorbency like ordinary paper or small surface energy (recording medium a or b) and has a high desired resolution such as 720 dpi, the number of ink drops emitted to each pixel is reduced to 2. On the other hand, when the same recording medium P has a low desired resolution such as 360 dpi, the number of ink drops emitted to each pixel is increased to 7 or 8. Further, when the recording medium P has low ink absorbency or large surface energy (recording medium c or d) and has a low desired resolution such as 360 dpi, the number of ink drops emitted to each pixel is increased to 10 or 12 and when the same recording medium P has a high desired resolution such as 720 dpi, the number of ink drops emitted to each pixel is reduced to 3. Further, FIG. 3(a) shows an example of the ink emission amount LUT and the ink emission amount LUT is not limited to the example shown here. For example, the kind of the recording medium P corresponding to the ink emission amount may be subdivided more and the resolution may be graded more finely.

Further, the maximum recording rate LUT, as shown in FIG. 3(b), is specified by making the ink emission amount correspond to an optimal maximum recording rate to image recording. The ink emission amount is the product of the number of ink drops emitted per each pixel and the amount of one drop and the maximum recording rate is a maximum rate of one color of pixels recorded per unit area. Further, to prevent an occurrence of sandy parts and uneven parts on the image surface and ensure a fixed or more density of recorded images, the maximum recording rate can be varied within a range from 80% to 95%.

Further, the correction amount by ink kind LUT, as shown in FIG. 3(c), is used to decide a correction amount such as how much to correct the maximum recording amount for each ink kind such as black (K), cyan (C), magenta (M), yellow (Y), light cyan (LC), and light magenta (LM) and is specified by making the kind of each ink correspond to the correction amount corresponding to it. For example, for ink of a dark color such as black (K), the effect appearing on a recorded image due to a difference in the ink amount is great, so that the maximum recording amount is corrected so as to record 90% of the maximum recording rate derived by the number of ink drops, while for ink of a light color such as yellow (Y) or light magenta (LM), even if the ink amount is large, images are not affected so much, so that the maximum recording rate derived by the number of ink drops is recorded straight without being corrected. Further, the LUT for deciding the correction amount by ink kind is not limited to the above illustration and for example, when there is a difference in the extent of dots on the recording medium P depending on the ink kind, a LUT for correcting the difference may be prepared. Further, the physical properties of ink, after the ink storage container is opened, may be changed with time, thus a difference may appear in the extent of dots on the recording medium P. In this case, a LUT for correcting such a difference may be prepared.

Next, the operation of this embodiment will be explained.

When image data input from an external device not drawn is sent to the ink jet recording apparatus 1, the sent image data is stored in the storage section 9 of the controlling section 8. And, when a signal of starting image recording and the kind and resolution of the recording medium P are input from the input section 10 by a user, the controlling section 8 reads the ink emission amount LUT stored in the storage section 9 and decides the ink emission amount corresponding to the input kind and resolution of the recording medium P. When the ink emission amount is decided, the controlling section 8 reads and refers to the maximum recording rate LUT stored in the storage section 9 and decides the maximum recording rate corresponding to the ink emission amount. Furthermore, the controlling section 8 reads the correction amount by ink kind LUT from the storage section 9, corrects the maximum recording rate according to the ink kind, and decides a final maximum recording rate.

When the maximum recording rate is decided, the controlling section 8 adds the decided maximum recording rate, then performs the multi-leveling process of image data by the dither method or error variance method, and decides pixels for recording images.

When the pixels for recording images are decided, the controlling section 8 controls the recording medium conveying mechanism 12, thus the recording medium P is sequentially conveyed intermittently from the upstream side in the sub-scanning direction Y to the downstream side. Further, the controlling section 8 controls the carriage drive mechanism 11, thereby moves the carriage 4 back and forth on the recording medium P in the main scanning direction X, and controls each recording head 6 so as to emit a predetermined emission amount of ink to a predetermined pixel. Ultraviolet rays are irradiated onto the ink emitted onto the recording medium P from the ultraviolet irradiating devices 7, thus the ink is cured and fixed, and an image is recorded on the recording medium P.

As mentioned above, according to this embodiment, depending on the recording medium P used for image recording, ink kind, desired resolution, and ink emission amount, the maximum recording rate for each color is decided, so that regardless of the kind of the recording medium P, images can always be recorded by an appropriate amount of ink. By doing this, an occurrence of sandy parts and uneven parts on the recorded image surface due to an excessive ink amount can be prevented. Further, the maximum recording rate per each color is set within a range from 80% to 95%, thus when visually checking a recorded image, the image quality has no influence such that the image is seen light, and high resolution image recording can be performed. Furthermore, before performing adjustment by the multi-leveling process such as the dither method or error variance method, the maximum recording rate per each color is decided, so that compared with a case that after multi-leveling, the maximum printing rate is decided, the image process can be performed quickly.

Further, in this embodiment, according to the kind of the recording medium P, resolution, ink kind, and ink emission amount, the maximum recording rate for each color is decided. However, on the basis of at least one of these factors, the maximum recording rate may be decided. Further, in this embodiment, from the kind of the recording medium P, resolution, and ink kind, the ink emission amount is decided first and from the decided ink emission amount, the maximum recording rate is derived. However, any one of the recording medium P, resolution, and ink kind or a combination of some of them may correspond to the maximum recording rate.

Further, the maximum recording rate for each color is advisable to be large enough to prevent sandy parts and uneven parts on the recording image surface due to an excessive ink amount and is not always limited to the range from 80% to 95%. Further, under the condition that even if ink is emitted in a large amount in the relationship between the kind of the recording medium P, resolution, ink kind, and ink emission amount, sandy parts and uneven parts are not produced on the recording image surface, it may be preset so as to select a maximum recording rate of 100%.

Further, in this embodiment, the ultraviolet irradiating devices 7 are arranged on both sides of the recording heads 6 installed in a group. However, the arrangement of the ultraviolet irradiating devices 7 is not limited to it and the ultraviolet irradiating devices 7 may be installed between the respective recording heads 6. Further, the ultraviolet irradiating devices 7 are not always loaded on the carriage 4 but may be installed outside the carriage 4.

Further, in this embodiment, even if the carriage 4 moves in any direction, the recording heads 6 emit ink and image recording is performed in two ways. However, only when the carriage 4 moves in a certain direction, the recording heads 6 may emit ink and image recording may be performed in one way. In this case, during image recording, the ultraviolet irradiating devices 7 positioned on the upstream side of the carriage 4 may be kept off. Furthermore, in an apparatus performing only image recording in one way, the ultraviolet irradiating devices 7 are installed only on one side of the recording heads 6 installed in one group and at time of image recording, while moving the carriage 4 so as to position the ultraviolet irradiating devices 7 on the downstream side in the main scanning direction X, image recording is performed.

Further, in this embodiment, image recording is performed using ink cured by irradiation of ultraviolet rays. However, ink is not limited to it and ink cured by irradiation of light other than ultraviolet rays such as electromagnetic waves, for example, ultraviolet rays, electron beams, X-rays, visible rays, and infrared rays may be used. In this case, to such ink, a polymerizable compound polymerized and cured by light other than ultraviolet rays and a photo-starting agent for starting polymerization reaction of polymerizable compounds by light other than ultraviolet rays are applied. Further, when using photo-curing ink cured by light other than ultraviolet rays, in place of the ultraviolet rays source, a light source for irradiating the light is applied.

Furthermore, ink cured without irradiation of light may be applied.

Further, the recording heads 6 used in the ink jet recording apparatus 1 of the present invention may be of an on-demand method or a continuous method. Further, as an emitting method, for example, among the electricity-machine conversion method (such as single cavity type, double cavity type, bender type, piston type, share mode type, shared wall type), the electricity-heat conversion method (such as thermal ink jet type, bubble jet (registered trademark) type), the electrostatic attraction method (such as electric field control type, slit jet type), and the discharge method (such as spark jet type), any emitting method may be used.

Further, the ink jet recording apparatus 1 of this embodiment is an ink jet recording apparatus 1 of a serial print method for moving back and forth the recording heads 6 loaded on the carriage 4 in the main scanning direction X, emitting ink from the recording heads 6 while conveying the recording medium P in the sub-scanning direction Y, thereby forming images. However, an ink jet recording apparatus of a line print method for emitting ink from recording heads fixed to the printer body and forming images while conveying the recording medium P may be used.

Furthermore, needless to say, the present invention is not limited to the embodiment aforementioned and can be modified properly.

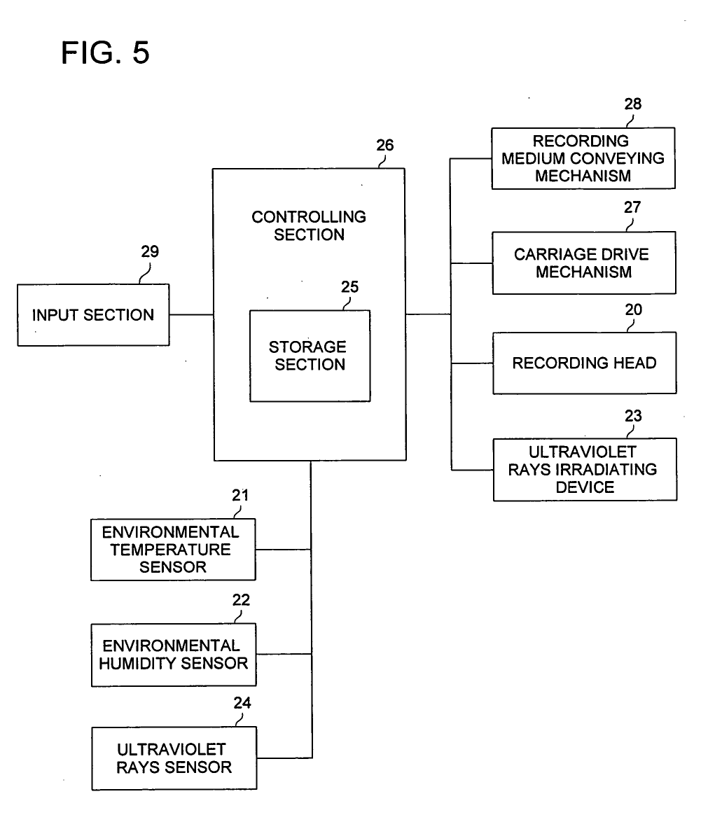

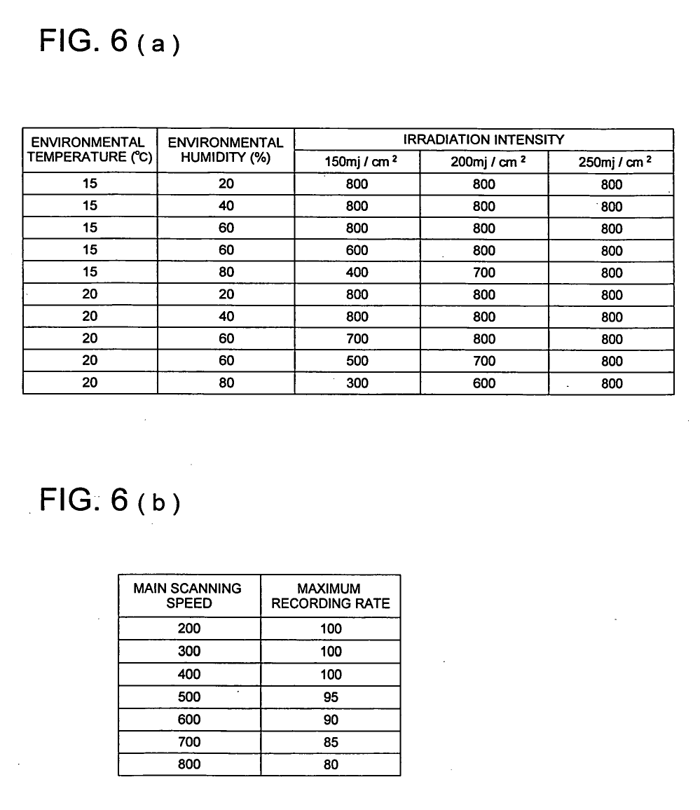

Next, by referring to FIGS. 5 and 6, the second embodiment of the ink jet recording apparatus relating to the present invention will be explained. The second embodiment is different from the first embodiment in a part of the apparatus constitution and only the control constitution, so that hereinafter, the differences from the first embodiment will be explained particularly.

In this embodiment, in the neighborhood of recording heads 20 of the ink jet recording apparatus, an environmental temperature sensor 21 and an environmental humidity sensor 22 for measuring the temperature and humidity around the recording heads 20 are installed. Further, in the neighborhood of an ultraviolet irradiating device 23, an ultraviolet sensor 24 for measuring the irradiation intensity of ultraviolet rays irradiated from the ultraviolet irradiating device 23 is installed.

Further, the ink jet recording apparatus, as shown in FIG. 5, in the same way as with the first embodiment, has a controlling section 26 equipped with a storage section 25 and controls a carriage drive unit 27 for driving back and forth the carriage in the main scanning direction, a recording medium conveying mechanism 28 for conveying a recording medium in the sub-scanning direction perpendicular to the main scanning direction, the recording heads 20, and the ultraviolet irradiating device 23. Further, to the controlling section 26, various information input from an input section 29, image data concerning recording images, and measured results measured by various sensors such as the environmental temperature sensor 21, the environmental humidity sensor 22, and the ultraviolet rays sensor 24 are sent. The controlling section 26 performs, for example, the multi-leveling process by the dither method or error variance method for the sent image data and then operates the recording heads 20 on the basis of the input information from the input section 29. By doing this, an appropriate emission amount of ink is emitted from the respective recording heads 20 and a predetermined image is recorded on the recording medium.

Similarly to the first embodiment, in the storage section 25, for example, various control programs (not drawn) concerning the operation of each unit of the ink jet recording apparatus and various data including control data (not drawn) relating to execution of various programs are stored and a main scanning speed look-up table (hereinafter, referred to as a “main scanning speed LUT”) and a maximum recording rate look-up table (hereinafter, referred to as a “maximum recording rate LUT”) are stored. The controlling section 26, as required, reads these various programs and LUTs from the ROM, stores them in the working area of the RAM, controls each unit of the apparatus, and decides a maximum recording rate in image recording.

Here, the main scanning speed LUT, as shown in FIG. 6(a), specifies the main scanning speed of the carriage corresponding to the environmental temperature in the neighborhood of the recording heads 20 measured by the environmental temperature sensor 21, the environmental humidity in the neighborhood of the recording heads 20 measured by the environmental humidity sensor 22, and the irradiation intensity of ultraviolet rays measured by the ultraviolet rays sensor 24.

Ink has a characteristic that it is easily cured at high temperatures and low humidity and is hardly cured at low temperatures and high humidity. Further, ink, as the amount of ultraviolet rays irradiated to the ink hit a recording medium increases, is easily cured and the amount of ultraviolet rays is the product of the irradiation intensity irradiated from the ultraviolet irradiating device 23 and the irradiation time. And, as the main scanning speed of the carriage is slowed down, the time of irradiation of ultraviolet rays to ink is prolonged, so that to cure ink appropriately, it is necessary to increase the irradiation intensity measured by the ultraviolet rays sensor 24 or to slow down the main scanning speed of the carriage. FIG. 6(a), from this mutual relation, makes the environmental temperature, environmental humidity, and irradiation intensity of ultraviolet rays correspond to the main scanning speed of the carriage.

Further, the maximum recording rate LUT, as shown in FIG. 6(b), is specified by making the main scanning speed of the carriage correspond to an optimal maximum recording rate to image recording, and as the main scanning speed is decreased, the time elapsing from emission of ink onto the recording medium to irradiation of ultraviolet rays is prolonged, and dots are extended with ink kept not cured, and the surface is smoothed, so that as the main scanning speed is decreased, even if ink is emitted much, sandy parts and uneven parts on the image surface are inconspicuous. Therefore, as the main scanning speed is decreased, the maximum recording rate is increased, and as the main scanning speed is increased, the maximum recording rate is decreased. Further, to prevent an occurrence of sandy parts and uneven parts on the image surface and ensure a fixed or more density of recorded images, the maximum recording rate can be varied within a range from 80% to 95%.

Further, the other constitution is the same as that of the first embodiment, so that the explanation thereof will be omitted.

Next, the operation of this embodiment will be explained.

When image data input from an external device not drawn is sent to the ink jet recording apparatus, the sent image data is stored in the storage section 25 of the controlling section 26. To the controlling section 26, from the environmental temperature sensor 21, the environmental humidity sensor 22, and the ultraviolet sensor 24, respective measured results are sent, and when a signal of starting image recording and various image recording conditions are input from the input section 29, the controlling section 26 reads the main scanning speed LUT stored in the storage section 25 and on the basis of the measured results measured by the environmental temperature sensor 21, the environmental humidity sensor 22, and the ultraviolet sensor 24, decides the main scanning speed of the carriage. When the main scanning speed of the carriage is decided, the controlling section 26 reads and refers to the maximum recording rate LUT stored in the storage section 25 and decides the maximum recording rate corresponding to the main scanning speed.

When the maximum recording rate is decided, the controlling section 26 adds the decided maximum recording rate, then performs the multi-leveling process of image data by the dither method or error variance method, and decides pixels for recording images.

When the pixels for recording images are decided, the controlling section 26 controls the recording medium conveying mechanism 28, thus a recording medium is sequentially conveyed intermittently from the upstream side in the sub-scanning direction to the downstream side. Further, the controlling section 26 controls the carriage drive mechanism 27, thereby moves the carriage back and forth on the recording medium in the main scanning direction, and controls each recording head 20 so as to emit a predetermined emission amount of ink to a predetermined pixel. Ultraviolet rays are irradiated onto the ink emitted onto the recording medium from the ultraviolet irradiating device 23, thus the ink is cured and fixed, and an image is recorded on the recording medium.

As mentioned above, according to this embodiment, depending on the measured results measured by the environmental temperature sensor 21, the environmental humidity sensor 22, and the ultraviolet sensor 24 and the main scanning speed of the carriage, the maximum recording rate for each color is decided, so that regardless of the environment for image recording and the performance of the ultraviolet irradiating device 23, images can always be recorded by an appropriate amount of ink. By doing this, an occurrence of sandy parts and uneven parts on the recorded image surface due to an excessive ink amount can be prevented. Further, the maximum recording rate per each color is set within a range from 80% to 95%, thus when visually checking a recorded image, the image quality has no influence such that the image is seen light, and high resolution image recording can be performed.

Further, in this embodiment, depending on the measured results measured by the environmental temperature sensor 21, the environmental humidity sensor 22, and the ultraviolet sensor 24 and the main scanning speed of the carriage, the maximum recording rate for each color is decided. However, on the basis of at least one of these factors, the maximum recording rate may be decided. Further, in this embodiment, from the measured results measured by the environmental temperature sensor 21, the environmental humidity sensor 22, and the ultraviolet sensor 24, the main scanning speed of the carriage is decided first and from the decided main scanning speed of the carriage, the maximum recording rate is derived. However, any one of the measured results measured by the environmental temperature sensor 21, the environmental humidity sensor 22, and the ultraviolet sensor 24 or a combination of some of them may correspond to the maximum recording rate.

Further, the maximum recording rate for each color is advisable to be large enough to prevent sandy parts and uneven parts on the recording image surface due to an excessive ink amount and is not always limited to the range from 80% to 95%. Further, under the condition that even if a large amount of ink is emitted in the relationship between the measured results measured by the environmental temperature sensor 21, the environmental humidity sensor 22, and the ultraviolet sensor 24 and the main scanning speed of the carriage, sandy parts and uneven parts are not produced on the recording image surface, it may be preset so as to select a maximum recording rate of 100%.

Further, by combining each factor of the measured results measured by the environmental temperature sensor 21, the environmental humidity sensor 22, and the ultraviolet sensor 24 and the main scanning speed of the carriage which are taken up in this embodiment and each factor of the kind of a recording medium, resolution, ink kind, and ink emission amount which are taken up in the first embodiment, the maximum recording rate may be decided.

Further, similarly to the first embodiment, the present invention is not limited to this embodiment.

### EMBODIMENT

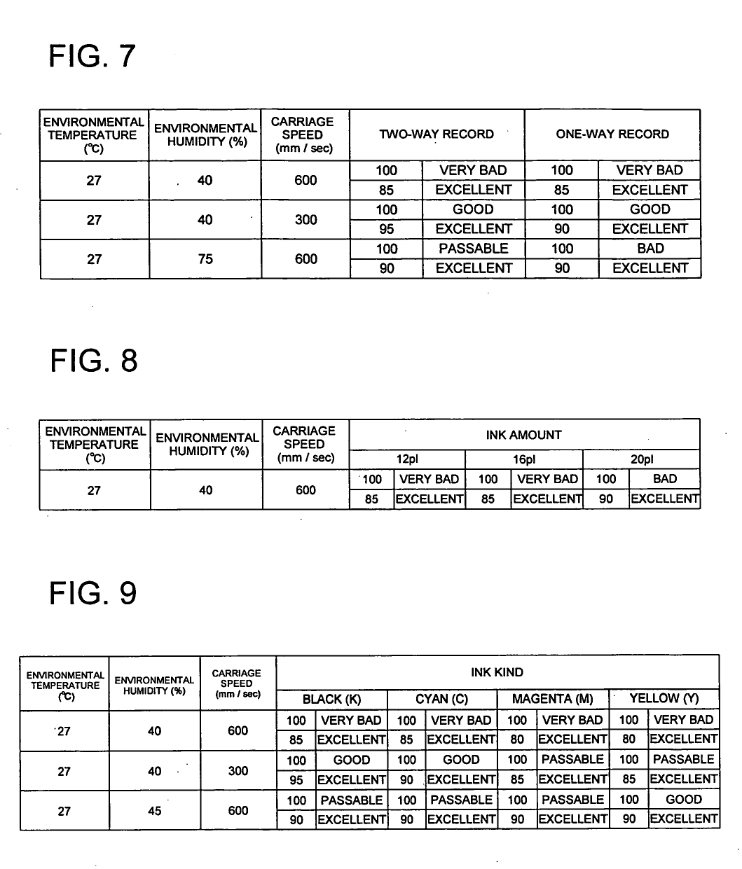

Next, by referring to FIGS. 7 to 11, the embodiment of the ink jet recording apparatus will be explained.

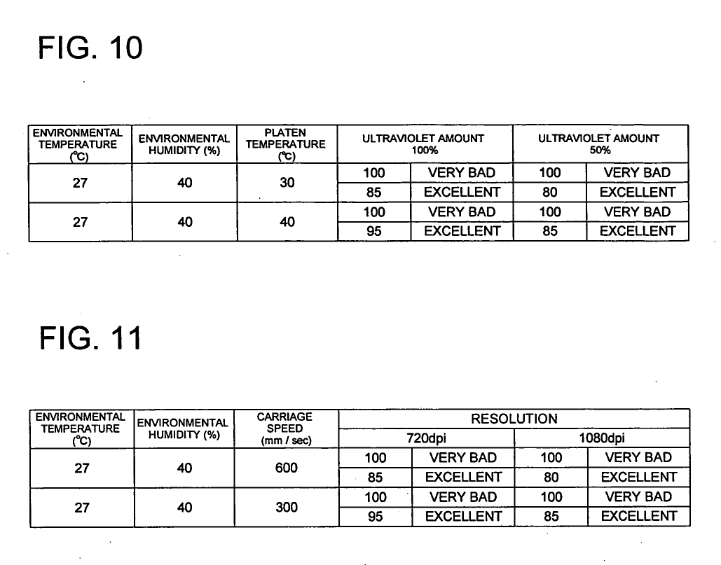

The ink jet recording apparatus 1 in this embodiment has an almost same constitution as that of the ink jet recording apparatus 1 shown in FIG. 1. The environmental temperature and environmental humidity shown in FIGS. 7 to 11 are those measured by the environmental temperature sensor and environmental humidity sensor installed in the neighborhood of the recording heads. Further, in the amount of ultraviolet rays shown in FIG. 10, the irradiation intensity of ultraviolet rays is measured by the ultraviolet sensor for measuring the irradiation intensity of ultraviolet rays installed in the neighborhood of the ultraviolet irradiating device, and the amount of ultraviolet rays when irradiated at an irradiation capacity of 100% of the ultraviolet irradiating device is assumed as 100%. Further, the platen temperature shown in FIG. 10 is measured by a platen temperature sensor (not drawn) installed on the platen or in the neighborhood thereof.

In FIG. 7, in the relationship between the environmental temperature, environmental humidity, carriage speed, and recording rate for each color, when visually checking recorded images, whether uneven parts can be seen on each image surface or not is evaluated in the five stages. In the drawing, Excellent means that uneven parts are not seen at all and the image quality is good, and Good means that few uneven parts are seen and the image quality is almost good, and Passable means that a few uneven parts are seen and the image quality is affected. Further, Bad means that uneven parts are seen considerably and the image quality is affected and Very bad means that uneven parts are seen clearly and the image quality is inferior.

Under the condition of an environmental temperature of 27° C. and environmental humidity of 40%, when performing image recording in two ways or in one way at a carriage speed of 600 m/s, if the recording rate for each color is 100%, uneven parts are seen clearly and the evaluation is Very bad. On the other hand, when the recording rate for each color is 85%, uneven parts are not seen at all and the evaluation is Excellent. Further, when the carriage speed is slow like 300 m/s, even if the recording rate for each color is 100%, few uneven parts are seen, and the evaluation is Good, and when the recording rate is 90%, the evaluation is Excellent. Further, when performing image recording under the condition of an environmental temperature of 27° C. and environmental humidity of 75%, even if the carriage speed is fast like 600 m/s, when the recording rate is 90%, the evaluation is Excellent.

In FIG. 8, in the relationship between the environmental temperature, environmental humidity, carriage speed, ink emission amount, and recording rate for each color, when visually checking recorded images, whether uneven parts can be seen on each image surface or not is evaluated in the five stages. The evaluation in the drawing is the same as that in FIG. 7.

Under the condition of an environmental temperature of 27° C. and environmental humidity of 40%, when performing image recording at a carriage speed of 600 m/s, even when the ink emission amount is small like 12 p1 or large like 20 p1, if the recording rate for each color is 100%, uneven parts are seen and the evaluation is Very bad or Bad. On the other hand, when the recording rate for each color is 85%, uneven parts are not seen at all and the evaluation is Excellent.

In FIG. 9, in the relationship between the environmental temperature, environmental humidity, carriage speed, ink kind, and recording rate for each color, when visually checking recorded images, whether uneven parts can be seen on each image surface or not is evaluated in the five stages. The evaluation in the drawing is the same as that in FIG. 7.

Under the condition of an environmental temperature of 27° C. and environmental humidity of 40%, when performing image recording at a carriage speed of 600 m/s, if the recording rate for each color is 100%, uneven parts are seen on the image surface regardless of the ink kind and the evaluation is Very bad. On the other hand, when the recording rate for each color is 85%, uneven parts are not seen at all regardless of the ink kind and the evaluation is Excellent. Further, when the carriage speed is slow like 300 m/s, even if the recording rate for each color is 100%, few uneven parts are seen for black (K) and cyan (C), and the evaluation is Good, and when the recording rate is 85%, the evaluation is Excellent for all the kinds of ink. Further, when performing image recording under the condition of an environmental-temperature of 27° C. and environmental humidity of 75%, even if the carriage speed is fast like 600 m/s, when the recording rate is 90%, the evaluation is Excellent regardless of the ink kind.

In FIG. 10, in the relationship between the environmental temperature, environmental humidity, platen temperature, amount of ultraviolet rays, and recording rate for each color, when visually checking recorded images, whether uneven parts can be seen on each image surface or not is evaluated in the five stages. The evaluation in the drawing is the same as that in FIG. 7.

Under the condition of an environmental temperature of 27° C., environmental humidity of 40%, and a platen temperature of 30° C., when performing image recording, if the recording rate for each color is 100%, uneven parts are seen on the image surface-regardless of the amount of ultraviolet rays irradiated and the evaluation is Very bad. On the other hand, when the amount of ultraviolet rays is 100%, if the recording rate for each color is 85%, the evaluation is Excellent, and when the amount of ultraviolet rays is 50%, if the recording rate for each color is 80%, the evaluation is Excellent. Further, under the condition of a platen temperature of 30° C., when the amount of ultraviolet rays is 100%, if the recording rate for each color is 95%, the evaluation is Excellent, and when the amount of ultraviolet rays is 50%, if the recording rate for each color is 85%, the evaluation is Excellent.

In FIG. 11, in the relationship between the environmental temperature, environmental humidity, carriage speed, resolution, and recording rate for each color, when visually checking recorded images, whether uneven parts can be seen on each image surface or not is evaluated in the five stages. The evaluation in the drawing is the same as that in FIG. 7.

Under the condition of an environmental temperature of 27° C. and environmental humidity of 40%, when performing image recording at a carriage speed of 600 m/s, if the recording rate for each color is 100%, uneven parts are seen on the image surface regardless of the resolution and the evaluation is Very bad. On the other hand, when the resolution is 720 dpi, if the recording rate for each color is 85%, the evaluation is Excellent, and when the resolution is 1080 dpi, if the recording rate for each color is 80%, the evaluation is Excellent. Further, under the condition of a carriage speed of 300 m/s, when the resolution is 720 dpi, if the recording rate for each color is 95%, the evaluation is Excellent, and when the resolution is 1080 dpi, if the recording rate for each color is 85%, the evaluation is Excellent.

According to the present invention, the following effects can be obtained.

(1) The ink amount for each color can be decreased while emitting ink so as to form larger dots than the theoretical pixel. By doing this, an occurrence of sandy parts and uneven parts on the recorded image surface due to an excessive ink amount can be prevented and even if the ink emission bending occurs, no stripes are produced between dots. Further, the maximum recording rate for each color is set within the range from 80% to 95%, so that when visually checking a recorded image, the image quality has no influence such that the image is seen light, and high resolution image recording can be performed.

(2) A recording medium differs in the ink absorbency and magnitude of surface energy depending on the kind thereof, so that the extent of ink after hitting the recording medium varies with the kind of the recording medium. The maximum recording rate for each color is decided according to the recording medium, so that the ink amount can be adjusted appropriately and high resolution image recording can be performed.

(3) The number of dots of ink emitted to each pixel varies with the resolution. However, the maximum recording rate for each color is decided according to the resolution, so that the whole ink amount can be adjusted appropriately, and high resolution image recording can be performed.

(4) Ink has a characteristic that when the temperature around the recording heads is low or the humidity is high, it is hardly cured, is not cured immediately after hitting a recording medium, and is extended and smoothed in the peripheral area, though when the temperature is high or the humidity is low, it is easily cured. In consideration of such a characteristic of ink, the maximum recording rate for each color is decided, so that high resolution image recording can be performed.

(5) The curing condition of ink emitted onto a recording medium varies with the light irradiation amount of the light irradiating device, and when the light irradiation amount is large, ink is cured immediately after hitting the recording medium, though when the light irradiation amount is small, it is not cured immediately after hitting and is extended and smoothed in the peripheral area. In consideration of such a difference in the curing condition of ink, the maximum recording rate for each color is decided, so that even if the number of times of scanning necessary until curing of ink differs, the apparatus can respond appropriately to it, and high resolution image recording can always be performed.

(6) When recording images using photo-curing ink, if the image recording velocity is fast, light is immediately irradiated to ink emitted onto the recording medium, thus the ink is cured immediately after hitting. On the other hand, if the image recording velocity is slow, light is not immediately irradiated to ink emitted onto the recording medium, thus before the ink is cured after hitting, it is extended and smoothed in the peripheral area. In consideration of such ink curing timing, the maximum recording rate for each color is decided, so that, for example, even in an ink jet recording apparatus capable of switching a recording operation at a different image recording velocity, an effect on high resolution image recording can be produced.

(7) When recording images using a plurality of colors of ink, the effect on images when the ink amount is large varies with the depth of ink, dark or light. Further, depending on the ink kind, how to cure may be changed. The maximum recording rate for each color is decided according to the ink kind, so that high resolution image recording can be performed in correspondence to various hinds of ink.

(8) In consideration of the liquid drop amount or the number of liquid drops of ink emitted from the recording heads, the maximum recording rate for each color is decided, so that the whole ink amount can be adjusted appropriately and an effect on high resolution image recording can be produced.

(9) After the maximum recording rate for each color is decided, adjustment by the multi-leveling process such as the dither method or error variance method is performed, so that in the recording apparatus for recording images after multi-leveling, compared with a case that after multi-leveling, the maximum printing rate is decided, the image process can be performed quickly, and the whole ink amount can be adjusted appropriately, and an effect on high resolution image recording can be produced.

Disclosed embodiment can be varied by a skilled person without departing from the spirit and scope of the invention.

What is claimed is:

1. An inkjet recording apparatus, comprising:
a recording head to emit a photo-curing ink, to be cured by irradiating a light, onto a recording medium;
a light irradiating device having a light source that irradiates said light onto said photo-curing ink emitted by said recording head; and
a controlling section to determine a maximum recording rate, so that said maximum recording rate is set at a value in a range of 80-95% when a recording rate of whole pixels to be recorded for every unicolor is set at 100%.

2. The inkjet recording apparatus of claim 1,
wherein said controlling section determines said maximum recording rate for every unicolor corresponding to a kind of said recording medium to be employed.

3. The inkjet recording apparatus of claim 1,
wherein said controlling section determines said maximum recording rate for every unicolor corresponding to a resolution.

4. The inkjet recording apparatus of claim 1, further comprising:
a measuring section to measure at least one of a temperature and a humidity around a peripheral area of said recording head;
wherein said controlling section determines said maximum recording rate for every unicolor corresponding to at least one of said temperature and said humidity measured by said measuring section.

5. The inkjet recording apparatus of claim 1, further comprising:
an irradiation intensity measuring section to measure an irradiation intensity of said light irradiated by said light irradiating device;
wherein said controlling section determines said maximum recording rate for every unicolor corresponding to said irradiation intensity measured by said irradiation intensity measuring section.

6. The inkjet recording apparatus of claim 1,
wherein said controlling section determines said maximum recording rate for every unicolor corresponding to a recording velocity at a time of a recording operation.

7. The inkjet recording apparatus of claim 1,
wherein said recording head corresponds to each of a plurality of recording heads and said photo-curing ink corresponds to each of a plurality of photo-curing inks, colors of which are different from each other; and
wherein each of said plurality of recording heads is disposed for each of said plurality of photo-curing inks and said controlling section determines said maximum recording rate for every unicolor corresponding to a kind of said photo-curing ink.

8. The inkjet recording apparatus of claim 1,
wherein said controlling section is capable of controlling at least one of an amount of ink and a number of ink particles to be emitted from said recording head, and determines said maximum recording rate for every unicolor corresponding to said amount of ink or said number of ink particles.

9. The inkjet recording apparatus of claim 1,
wherein, after said maximum recording rate is determined, said controlling section conducts a multiple-value conversion processing suitable for said inkjet recording apparatus to determine pixels to be recorded for every unicolor, and conducts a controlling operation to emit said photo-curing ink corresponding to said pixels determined to be recorded.

10. The inkjet recording apparatus of claim 1,
wherein said light is defined as activation energy rays for curing said photo-curing ink.

11. An inkjet recording method, comprising the steps of:
emitting a photo-curing ink, to be cured by irradiating a light, onto a recording medium; and
irradiating said light onto said photo-curing ink adhered to said recording medium;
determining a maximum recording rate for every unicolor, so that said maximum recording rate is set at a value in a range of 80-95% when a recording rate of whole pixels to be recorded for every unicolor is set at 100%.

12. The inkjet recording method of claim 11,
wherein said maximum recording rate for every unicolor is determined corresponding to a kind of said recording medium to be employed.

13. The inkjet recording method of claim 11,
wherein said maximum recording rate for every unicolor is determined corresponding to a resolution.

14. The inkjet recording method of claim 11, further comprising the step of:
measuring at least one of a temperature and a humidity around a peripheral area of said recording head;
wherein said maximum recording rate for every unicolor is determined corresponding to at least one of said temperature and said humidity measured in said measuring step.

15. The inkjet recording method of claim 11, further comprising the step of:
measuring an irradiation intensity of said light irradiated in said irradiating step;
wherein said maximum recording rate for every unicolor is determined corresponding to said irradiation intensity measured in said measuring step.

16. The inkjet recording method of claim 11,
wherein said maximum recording rate for every unicolor is determined corresponding to a recording velocity at a time of a recording operation.

17. The inkjet recording method of claim 11,
wherein said maximum recording rate for every unicolor is determined corresponding to a kind of said photo-curing ink.

18. The inkjet recording method of claim 11, further comprising the step of:
controlling at least one of an amount of ink and a number of ink particles to be emitted in said emitting step;
wherein said maximum recording rate for every unicolor is determined corresponding to said amount of ink or said number of ink particles.

19. The inkjet recording method of claim 11,
wherein, after said maximum recording rate is determined, a multiple-value conversion processing is conducted to determine pixels to be recorded for every unicolor, and then, a controlling operation is conducted to emit said photo-curing ink corresponding to said pixels determined to be recorded.

20. The inkjet recording method of claim 11,
wherein said light is defined as activation energy rays for curing said photo-curing ink.
